(19) United States
(12) Patent Application Publication
(10) Pub. No.: US 2006/0013730 A1
(43) Pub. Date: Jan. 19, 2006

(54) Method and apparatus for handling labware within a storage device

(76) Inventors: Paul Wayne Pollock, Nashville, TN (US); John Randall Vinson, Franklin, TN (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/180,644

(22) Filed: Jul. 14, 2005

Related U.S. Application Data
(60) Provisional application No. 60/588,338, filed on Jul. 16, 2004.

(51) Int. Cl. G01N 35/00

(52) U.S. Cl. 422/63

(57) ABSTRACT

A method and apparatus capable of transporting SBS and non-SBS labwares, along with other varying types of labware, to and from a storage facility without requiring retooling or reprogramming. The apparatus includes an arm movable between an extended and a retracted position. Abutments are disposed on the arm, each abutment includes abutting surfaces configured to support the labware during transport. The apparatus also comprises a guide consisting of rails. The rails are configured to center the labware on the arm and in some embodiments lift the labware from the arm.

### CROSS-REFERENCE TO RELATED APPLICATIONS

This application claims priority to and is a continuation of provisional U.S. patent application entitled, METHOD AND APPARATUS FOR HANDLING LABWARE WITHIN A STORAGE DEVICE, filed Jul. 16, 2004, having a Ser. No. 60/588,338, the disclosure of which is hereby incorporated by reference in its entirety.

### FIELD OF THE INVENTION

The present invention relates generally to handling devices. More particularly, the present invention relates to a microplate handler compatible with SBS (Society for Biomolecular Screening) and non-SBS microplate formats. The microplate handler is configured to transport the microplates to and from a storage location.

### BACKGROUND OF THE INVENTION

Determining and achieving the proper conditions that allow a protein to crystallize from solution often requires many attempts before the proper concentrations of protein and reagents are determined and achieved. Furthermore, even when the conditions permit crystallization, the rate of crystallization is often very slow, at times on the order of weeks or even months. As a result, manually performing protein crystallization experiments is a very labor and time intensive process. One method of increasing the chances of obtaining protein crystals in the first experiment, thus saving a significant amount of time, is to try as many different protein and reagent concentrations as possible in the initial experiment.

Because protein crystallization experiments have traditionally been carried out in labware, such as microplates, labware storage hotels have been developed to store the numerous types of labware prepared during the course of the experiment. Furthermore, because the preparing of the vast number of microplates and the periodic checking of each microplate for protein crystals are so labor intensive, robotic microplate handlers have been developed.

Unfortunately there is a myriad of different microplate vendors and therefore a large variation in microplate formats used in the industry. These varying microplate sizes exist despite the Society for Biomolecular Screening's (SBS) attempt to standardize a single microplate format.

Because of the varying sizes of microplates, handlers have difficulty handling them. These handlers are not effective if the scientist operating them has to retool the handler for each microplate in the system. In order to streamline the experiment and allow for maximum efficiency, automated equipment, such as robotic microplate handlers, should be designed to accept both SBS and non-SBS formats. Without such devices, scientists spend their valuable time changing out tooling or reprogramming the robotic microplate handlers for each different microplate.

Accordingly, it is desirable to provide a method and apparatus capable of handling SBS and non-SBS microplates, along with other varying types of labware.

### SUMMARY OF THE INVENTION

The foregoing needs are met, to a great extent, by the present invention, wherein an embodiment in accordance with the present invention provides a method and apparatus capable of transporting SBS and non-SBS microplates, along with other varying types of labware, to and from a storage facility without requiring retooling or reprogramming.

In accordance with one embodiment of the present invention is an apparatus for handling a labware located within a storage system, comprising: an arm movable between an extended and a retracted position; an abutment disposed on the arm, having a number of steps, and configured to support the labware; a guide having a number of rails and configured to center the labware; and a clamp movable between an open and a closed position and configured to bias the labware against the abutment.

In accordance with another embodiment of the present invention, is a method for handling a labware, comprising: providing an arm configured to handle the labware, wherein the arm comprises an abutment having at least two sets of steps; moving the arm from a retracted position to a position proximate to the labware; opening a clamp so as to provide an opening configured to house the labware; disposing the labware in the opening; moving the arm having the labware located thereon from the extended position toward the retracted position; and closing the clamp so as to bias the labware against at least a portion of one of the sets of steps.

In accordance with yet another embodiment of the present invention, is an apparatus for handling a labware, comprising: means for supporting the labware, wherein the means for supporting is configured to translate between an extended position and a retracted position; means for securing the labware onto the means for supporting; means for centering the labware; and means for biasing the labware configured to bias the labware against the means for securing.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of the present invention illustrating the labware handler in an extended position.

FIG. 2 is a perspective view of the present invention illustrating the labware handler in a retracted position.

FIG. 3 is a perspective view of the present invention incorporated in a vertical drive system.

### DETAILED DESCRIPTION

The invention will now be described with reference to the drawing figures, in which like reference numerals refer to like parts throughout. An embodiment in accordance with the present invention provides a method and apparatus capable of transporting SBS and non-SBS microplates, along with other varying types of labware, to and from a storage facility without requiring retooling or reprogramming.

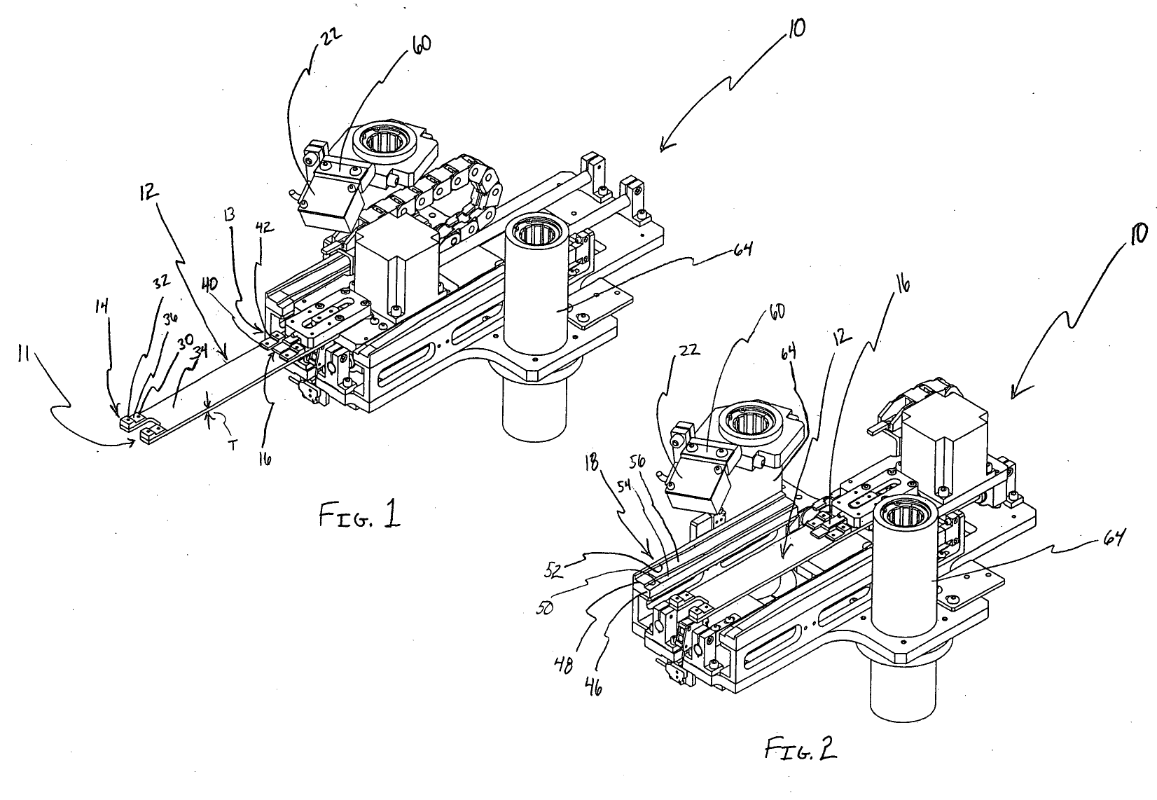

An embodiment of the present inventive apparatus and method is illustrated in FIG. 1. The present invention is a microplate handler 10 that transports varying types of labware without necessitating tooling changes, adjustments, reprogramming, or retrofitting. The microplate handler 10 includes an arm 12, an abutment 14, a clamp 16, a guide 18, a drive system 20, and a bar code reader 22.

The arm 12 is movable between an extended position and a retracted position. In an embodiment, a motorized rack and pinion drives the arm 12 between the extended position and the retracted position. FIG. 1 illustrates the arm 12 in an extended position. The arm 12 has a first 11 and second 12 end and a low profile, as illustrated by thickness T. T is sized such that the arm 12 is suitable for, and effective in, varying environments. For example, T enables arm 12 to extend into storage locations having a limited access space. The limited space, for example, can be the result of a slight distinction between the dimensions of the storage cell opening and the dimensions of the microplate stored therein. Also, T is thin such that a thick microplate may be transported, via arm 12, into the microplate handler 10 without interference with other handler 10 components.

Abutments 14 are disposed on the arm 12 and configured to secure the microplates on the arm 12. In an embodiment the arm 12 is rectangular, and an abutment 14, for example, is disposed on each corner of the arm 12. Thus, in an embodiment, four abutments are disposed on the arm 12. Each abutment 14 includes abutting surfaces or steps 30 and 32.

When handling a SBS formatted microplate, abutting surfaces 30 combine to create a securing surface that encompasses the outer perimeter of the SBS microplate or a portion thereof. Further securing the SBS microplate, by supporting its weight, is a flat surface 34 of the arm 12. Together, the abutting surfaces 30 and flat surface 34 provide a nest for securing the SBS microplate on the arm 12.

Likewise, handling a non-SBS formatted microplate, abutting surfaces 32 combine to create a securing surface that encompasses the outer perimeter of the non-SBS microplate. Further securing the non-SBS microplate, by supporting its weight, are flat surfaces 36 of the abutments 14. Together, the abutting surfaces 32 and flat surfaces 36 provide a nest for securing the SBS microplate on the arm 12.

It should be appreciated that each abutment 14 includes steps in addition to steps 30 and 32. The additional steps can be located on either or both sides of steps 30 and 32. For example, some non-SBS formatted microplates are smaller than SBS formatted microplates. Therefore, the abutment 14 includes steps located inside of steps 30 so as to secure the non-SBS formatted plate.

In an embodiment, there exists a corresponding number of abutting and flat surfaces because the abutting and flat surfaces combine to create a nest for the microplate while on the arm 12. It should be appreciated that abutments 14 comprise steps in addition to steps 30 and 32. Accordingly, it should also be appreciated that additional flat surfaces will be provided to support the weight of the microplates.

A clamping device 16 is at least partially disposed on the arm 12. The clamping device 16 is configured to align and further secure microplates of SBS and non-SBS formats. The clamping device 16 comprises abutting surfaces or steps 40 and 42. Steps 40 and 42 correspond with and move relevant to steps 30 and 32. It should be appreciated that the clamping device 16 and the abutment 14 include an equal number of steps relative to each other.

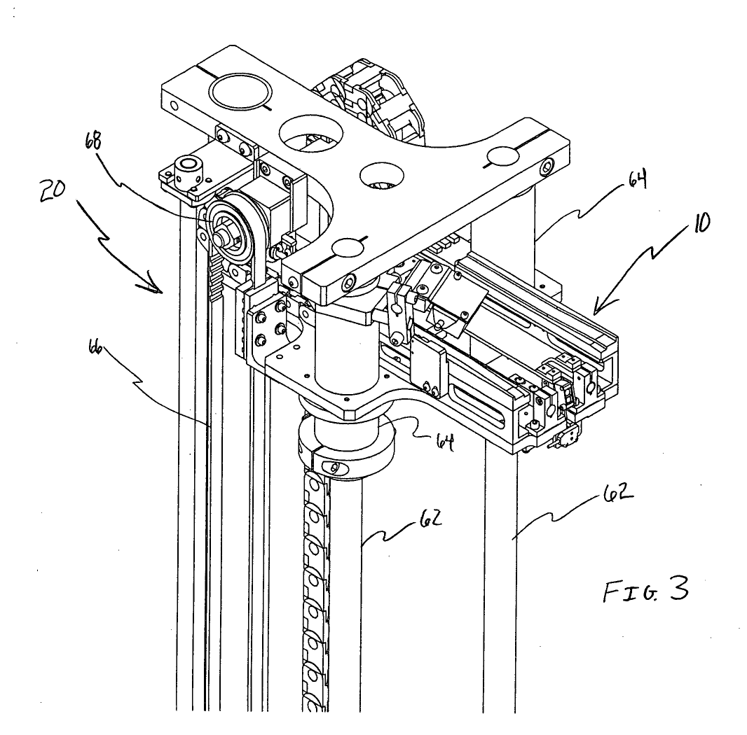

The clamping device 16 includes a cam (not shown) configured to open when the arm 12 extends and close when the arm 12 retracts. The position of the clamping device 16 is directly related to the position of the cam. For example, the clamping device 16 opens as the cam opens and the clamping device 16 closes as the cam closes. Simply put, the clamping device 16 closes as the arm 12 retracts and the clamping device 16 opens as the arm 12 extends. FIG. 1 illustrates the clamping device 16 in an open position and FIG. 2 illustrates the clamping device 16 in a closed position.

When closing, the clamping device 16 functions similar to a forward active crowder. For example, the clamping device 16, as it moves from an open to a closed position, forces or biases the microplate against the corresponding abutting surface 30 or 32, thereby securing the microplate for transporting. Specifically, when the clamping device 16 closes, abutting surfaces 40 and 42 move toward the first end 11 of the arm 12 and the inside of abutting surfaces 30 and 32, which are disposed proximate to the second end 13 of the arm 12.

In other words, when the clamping device is closed, abutting surfaces 40 and 42 are closer to the first end 11 of the arm 12 than abutting surfaces 30 and 32 of the second end 13 of the arm 12. Once the clamping device 16 is closed, abutting surface 40 or 42 contacts the microplate and, in doing so, biases the microplate against abutting surfaces 30 or 32, which is disposed proximate to the first end 11 of the arm 12.

If the microplate, for example, is of SBS format, step 40 of the clamping device 16 biases the microplate against step 30 of the abutments 14 located proximate to the first end 11 of the arm 12. Similarly, if the microplate is of non-SBS format, step 42 of the clamping device 16 biases the microplate against step 32 of abutments 14 located proximate to the first end 11 of the arm 12. It should be appreciated that the clamping device 16 includes steps in addition to steps 40 and 42. The additional steps can be located on either or both sides of steps 40 and 42. For example, some non-SBS formatted microplates are smaller than SBS formatted microplates. Therefore, the clamping device 16 includes steps located inside of step 40 so as to secure the non-SBS formatted plate.

When opening, the clamping device 16 moves from a closed, forward crowding position, toward an open position. When the clamping device 16 opens, steps 40 and 42 move toward the second end 13 of the arm 12 and beyond steps 30 and 32. In other words, when the clamping device 16 is open, steps 40 and 42 are closer to the second end 13 of the arm 12 than steps 30 and 32 of the abutments 14 located proximate to the second end 13 of the arm 12. Thus, when the clamping device 16 is open, a SBS microplate can nest, unobstructed, on flat surface 34 because step 40 is retracted out of the way. Similarly, when the clamping device 16 is open, a non-SBS microplate can nest, unobstructed, on flat surfaces 36 because step 42 is retracted out of the way.

It should be appreciated that, when the clamping device 16 is fully open, flat surfaces 34 and 36 are long enough to provide ample clearance for disposal of the microplates thereon. The ample clearance provides a comfortable margin of error when loading microplates onto the arm 12. In other words, for example, because of the ample clearance, the arm 12 does not have to be perfectly aligned with a SBS microplate for the microplate to fit within space provided between the steps 30 of the first end 11 of the arm 12 and the steps 30 of the second end 13 of the arm 12. Also, the ample clearance enables a non-SBS microplate to fit comfortably within the space provided between the steps 32 of the first end 11 of the arm 12 and the steps 32 of the second end 13 of the arm 12.

Now turning to FIG. 2, the guide 18 includes tapered rails 46 and 48, each having corresponding side surfaces 50 or 52 and top surfaces 54 or 56. In an embodiment configured to handle SBS microplates, the top surfaces 54 of the tapered rails 46 correspond to the flat surface 34 of the arm 12. Accordingly, when the arm 12 is in a retracted position inside the microplate handler 10, the flat surface 34 is proximately inline with the top surfaces 54. In this embodiment, the flat surface 34 and the top surfaces 54 combine to provide a flat surface on which a SBS microplate can rest during transport.

When the arm 12 is retracted inside the microplate handler 10, side surfaces 50 contact, and thereby laterally stabilize, the SBS microplate disposed therein. As such, side surfaces 50 of the tapered rails 46 are a part of the nest in which the SBS microplate is secured. Additionally, the side surfaces 50 move the SBS microplate to the center of the flat surface 34.

For example, a SBS microplate can be disposed in the nest created by abutting surfaces 30 and 40 and flat surface 34. As the arm 12, having the SBS microplate disposed thereon, is retracted into the microplate handler 10, where the top surfaces 54 and the side surfaces 50 combine to further support the SBS microplate. Further, because the tapered rails 46 are tapered inward, the side surfaces 50 contact and thereby move the SBS microplate toward the center of the arm 12 as the arm 12 retracts into the microplate handler 10.

In an embodiment configured to handle non-SBS microplates, the top surfaces 56 of the tapered rails 48 correspond to the flat surfaces 36 of the abutment 14, which is disposed on the arm 12. Accordingly, when the arm 12 is in a retracted position inside the microplate handler 10, the flat surfaces 36 are proximately inline with the top surfaces 56. In this embodiment, the flat surfaces 36 and the top surfaces 54 combine to provide flat surfaces on which the non-SBS microplate can rest during transport.

When the arm 12 is retracted inside the microplate handler 10, side surfaces 52 contact and thereby laterally stabilize the non-SBS microplate. As such, side surfaces 52 of the tapered rails 48 are a part of the nest in which the non-SBS microplate is transported. Additionally, the side surfaces 52 move the non-SBS microplate in the center of the arm 12.

For example, a non-SBS microplate can be disposed in the nest created by abutting surfaces 32 and 42 and flat surfaces 36. As the arm 12, having the non-SBS microplate disposed thereon, is retracted into the microplate handler 10, where the top surfaces 56 and the side surfaces 52 combine to further support the non-SBS microplate. Further, because the tapered rails 48 are tapered inward, the side surfaces 52 contact and thereby move the non-SBS microplate toward the center of the arm 12 as the arm 12 retracts to a transporting position inside the microplate handler 10.

It should be appreciated that the guide 18 includes rails in addition to tapered rails 46 and 48. The additional rails can be located on either or both sides of rails 46 and 48. For example, some non-SBS formatted microplates are smaller than SBS formatted microplates. Therefore, the guide 18 includes rails located inside of rails 46 so as to secure the non-SBS formatted plate.

In another embodiment, top surfaces 54 and 56 are tapered in an upward and retracting direction, in addition to side surfaces 50 and 52 tapering inward. As the arm 12 retracts into the microplate handler 10, the microplate progresses, in an upward direction, along the tapered portion of the top surfaces 54 or 56. This progressive, upward, movement smoothly transitions the weight of the microplate from the arm 12 to the guide 18. It is advantageous to rest the microplate on the guide 18, instead of the arm 12, during transporting because the guide 18 is more secure than the arm 12.

The tapered portions of the side and top surfaces 50, 52, 54 and 56 prevent imperfections of the microplate handler 10 from disabling the overall function of the microplate handler 10. For example, the tapers at the entryway of the guide 18 provide tolerance for error in the relationship between the arm 12 and the guide 18 and, as a result, the arm 12 does not have to perfectly deliver the microplate inline with the guide 18. In other words, the tapers provide a large opening for the for the microplate to enter the guide 18, and as the microplate progresses into the handler 10, the rails 46 and 48 taper inward and upward so as to funnel the microplate to a secure, nested, and central position inside the microplate handler 10.

Tapered top surfaces 54 and 56 are also advantageous when extending the arm from a retracted position inside the microplate handler 10. As the arm 12 extends from the microplate handler 10, the microplate progresses, in a downward and extending direction, along the tapered portion of the top surfaces 54 or 56. This progressive, downward, movement smoothly transitions the weight of the microplate from the guide 18 to the arm 12.

The total vertical increase of the upward taper of rails 46 and 48 is slightly less than the vertical increase of abutting surfaces 34 and 36. This ensures that, when the arm 12 is extending out of the microplate handler 10, the abutting surfaces 34 or 36 extend far enough from the arm 12 so as to contact the microplate and thereby move the microplate along the top surfaces 54 or 56. If the vertical increase of the upward taper is more than the vertical increase of abutting surfaces 34 and 36, then the abutting surfaces 34 and 36 will not extend far enough from the arm 12 to contact the microplate when the microplate is secured inside the plate handler 10, atop the top surfaces 54 or 56. Thus, when the arm extends, the abutting surfaces 30 or 32 will not contact the microplate and therefore pass underneath the microplate, leaving the microplate nested on the guide 18.

A barcode scanner 22 is disposed integral with the microplate handler 10. The barcode scanner 22 scans barcodes located on the microplates and the storage location. Information obtained via the barcode scanner 22 is utilized to efficiently and effectively facilitate the experiment. An adjustable bracket 60 fastens the barcode scanner 22 to the microplate handler 10. The adjustable bracket 60 enables inline positioning of the barcode scanner 22 relative to locations where barcodes are subject to scanning. The bracket 60 is lockable to promote repetition. Once the barcode scanner 22 is locked into position by the adjustable bracket 60, no further adjustments are necessary because a single position can serve both SBS and non-SBS microplates.

As shown in FIG. 3, the microplate handler 10 includes a belt-pulley drive system 20. For example, a shaft 62 is passed though each cylinder 64. A belt 66, fastened to the microplate handler 10, is looped around pulleys 68. At least one of the pulleys 68 is powered by a motor. The motor rotates the pulley 68 and thus the belt 66 travels along all of the pulleys 68. Because the microplate handler 10 is fastened to the belt 66, the microplate handler 10 travels in sync with the belt 66. Therefore, the microplate handler 10 travels parallel to the axis of the shafts 62. It should be appreciated that the plate handler 10 can be driven by a geared drive system or a motorized rack and pinion.

The microplate handler 10 is equipped with sensors to detect whether a microplate is present in the intended storage location. The sensors also detect whether the microplate is present in the microplate handler 10. Additionally, the microplate handler 10 includes a sensor configured to automatically align the position of the plate handler 10 with the center of each storage location.

In operation, when the microplate handler 10 begin the retrieval process, the arm 12 first moves from a retracted position, inside the microplate handler 10, to an outward position proximate to the stored microplate. As the arm 12 extends outward away from the microplate handler 10, a cam moves the clamp 16 in an opposite, inward direction. As a result of the clamp 16 movement, abutting surfaces 40 and 42 are positioned outside of the area between the abutting surfaces 30 and 32 on the first end 11 of the arm 12 and the abutting surfaces 30 and 32 on the second end 13 of the arm 12. This avails the entire flat surfaces 34 and 36 to the microplate, and thus provides ample clearance for the microplate to nest on the arm 12.

Next, the microplate handler 10 moves in a direction perpendicular to the direction in which the arm 12 moves. This movement disposes the microplate on the arm 12. Once the microplate is disposed on the arm 12, the arm 12 moves from the extended position toward the retracted position inside the microplate handler 10.

As the arm 12 retracts, the cam moves the clamp 16 in an opposite, outward direction so as to bias the microplate against the abutting surfaces 30 or 32 located, opposite the clamp 16, on the first end 11 of the arm 12. This biasing action not only provides a positive clamp for the microplate during transfer, but also results in an accurate and repeatable position for placing the microplate back into the storage location.

Also as the arm 12 retracts, the microplate contacts the tapered portion of the flat surfaces 54 or 56 and the tapered portion of the side surfaces 50 and 52. The retracting arm 12 moves the microplate along the surfaces 50 or 52, and 54 or 56 until the microplate is centrally and securely nested inside the microplate handler 10.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An apparatus for handling a labware located within a storage system, comprising:
an arm movable between an extended and a retracted position;
an abutment disposed on the arm, having a number of steps, and configured to support the labware;
a guide having a number of rails and configured to center the labware; and
a clamp movable between an open and a closed position and configured to bias the labware against the abutment.

2. The apparatus of claim 1, wherein the rails include a side surface having a tapered portion configured to center the labware.

3. The apparatus of claim 2, wherein the rails include a top surface having a tapered portion configured to lift the labware from the arm.

4. The apparatus of claim 3, wherein a flat portion of the side surface and a flat portion of the top surface combine to create a securing nest for the labware.

5. The apparatus of claim 3, wherein a height of the steps exceeds a height of the rails so as to facilitate contact between the steps and the labware while the labware is lifted from the arm by the tapered portion of the top surface.

6. The apparatus of claim 3, wherein the top surface comprises a flat portion and the arm is substantially inline with the flat portion.

7. The apparatus of claim 1, wherein the labware is a microplate.

8. A method for handling a labware, comprising:
providing an arm configured to handle the labware, wherein the arm comprises an abutment having at least two sets of steps;
moving the arm from a retracted position to a position proximate to the labware;
opening a clamp so as to provide an opening configured to house the labware;
disposing the labware in the opening;
moving the arm having the labware located thereon from the extended position toward the retracted position; and
closing the clamp so as to bias the labware against at least a portion of one of the sets of steps.

9. The method of claim 8, further comprising centering the labware by moving the labware along a guide having at least two sets of rails.

10. The method of claim 9, wherein the rails include a side surface having a tapered portion configured to center the labware on the arm.

11. The method of claim 10, wherein the rails include a top surface having a tapered portion configured to lift the labware from the arm.

12. The method of claim 11, wherein a flat portion of the side surface and a flat portion of the top surface combine to create a securing nest for the labware.

13. The method of claim 11, wherein a height of the steps exceeds a height of the rails so the steps maintain contact with the labware while the labware is lifted from the arm.

14. The method of claim 11, wherein the top surface comprises a flat portion and the arm is substantially inline with the flat portion.

15. The method of claim 8, wherein the number of sets of steps corresponds to the number of sets of rails.

16. The method of claim 8, wherein the labware is a microplate.

17. An apparatus for handling a labware, comprising:
means for supporting the labware, wherein the means for supporting is configured to translate between an extended position and a retracted position;
means for securing the labware onto the means for supporting;
means for centering the labware; and
means for biasing the labware configured to bias the labware against the means for securing.

18. The apparatus of claim 17, wherein the means for securing is an abutment disposed on the means for supporting, having a set of steps, and configured to handle the labware.

19. The apparatus of claim 18, wherein the means for centering is a guide having a set of rails and configured to center the labware.

20. The apparatus of claim 17, wherein the means for biasing is a clamp movable between an open position and a closed position and configured to bias the labware against the means for securing.

21. The apparatus of claim 19, wherein the rails include a side surface having a tapered portion configured to center the labware.

22. The apparatus of claim 21, wherein the rails include a top surface having a tapered portion configured to lift the labware from the arm.

23. The apparatus of claim 22, wherein a flat portion of the side surface and a flat portion of the top surface combine to create a securing nest for the labware.

24. The apparatus of claim 22, wherein a height of the steps exceeds a height of the rails so the steps maintain contact with the labware while the labware is lifted from the arm.

25. The apparatus of claim 22, wherein the top surface comprises a flat portion and the arm is substantially inline with the flat portion.

26. The apparatus of claim 19, wherein the number of sets of steps corresponds to the number of sets of rails.
